(19) United States
(12) Patent Application Publication
(10) Pub. No.: US 2003/0086126 A1
(43) Pub. Date: May 8, 2003

(54) Method of enhancing modulation transfer function performance

(76) Inventor: Shih-Zheng Kuo, Taipei Hsien (TW)

Correspondence Address: J.C. Patents, Inc., Suite 250, 4 Venture, Irvine, CA, 92618, US

(21) Appl. No.: 10/005,535

(22) Filed: Nov. 8, 2001

(51) Int. Cl. H04N 1/04; H04N 1/047; H04N 1/10; H04N 1/191; H04N 1/40

(52) U.S. Cl. 358/447; 358/494; 358/497

(57) ABSTRACT

A method of enhancing modulation transfer function performance, applicable to a method of scanning an object using a scanner with a linear sensor. A smooth image digital data is obtained. The object is scanned in a forwarding direction and a direction perpendicular to the forwarding direction of the scanner. According to the smooth image digital data, the digital data of calculation pixel obtained by using the scanning to scan the object are processed.

### BACKGROUND OF THE INVENTION

1. Field of the Invention

The invention relates in general to a method enhancing performance of the modulation transfer function (MTF), and more particularly, to a method of enhancing scan resolution and modulation transfer function by X-Y directional scans and specific calculation.

2. Description of the Related Art

The image conversion apparatus in copy machines, fax machines and scanners that converts a visual image into an appropriate electronic form for printing, storage, transmission or other electronic application typically uses a sensor such as charge coupled device (CCD) or contact image sensor (CIS) to detect the image. To a color display, the common structure of the sensor is formed of red, green and blue CCD device arrays. Normally, all the CCD devices are exposed for a certain period of time. The detected charges are then transmitted to an analog shift register for subsequent process.

To enhance the resolution along the X-axis (the major axis of the sensor), interpolation is performed on the X-axis to obtain data with an optical resolution larger than that of the sensor. However, as the sizes of sensor cells of the sensor are not variable, the brightness obtained by the sensor cells of the sensor is constant. If each sensor cell uses an optical resolution larger than the actual resolution of the sensor, the scanned data is the average value of the brightness for several pixels. The performance of the modulation transfer function for the scanner is degraded.

### SUMMARY OF THE INVENTION

The invention provides a method of enhancing modulation transfer function performance. An image smooth region and an object to be scanned are scanned using a sensor. By moving the sensor in two perpendicular directions, an improved resolution in the X-axis (the major axis of the optical sensor) is obtained.

The method of enhancing modulation transfer function performance is applicable to a method of scanning an object using a scanner that comprises a linear sensor. The method includes the following steps. Smooth image digital data are obtained. The object is scanned in the scan-forwarding direction and a direction perpendicular to the scan-forwarding direction. Processing is performed according to the smooth image digital data and the calculation pixel digital data obtained by scanning.

In the above method, the calculation pixel digital data obtained by scanning can be processed according to the smooth image digital data as:

When X>(N−1),

A(X)=F(X)*N−A(X−1)−A(X−2)− . . . −A(X−N+1); and

When X<N,

A(X)=F(X)*N−A(X−1)−A(X−2)− . . . −A(0)*(N−X).

In the above equations, (X−1) is the number of calculation pixels for digital data obtained before the current step of obtaining calculation pixels. N is the number of calculation pixels included in a sensor cell. A(X) is the digital data corresponding to the Xth calculation pixel. F(X) is the digital data obtained using the sensor cell to scan the obtained calculation pixels.

According to the above, the invention uses a motor to drive an optical sensor, so as to move along the X-axis and the Y-axis. With the data obtained by scanning the image smooth area, the scan resolution of the scanner on X-axis and Y-axis is enhanced. Further, the modulation transfer function is enhanced.

Both the foregoing general description and the following detailed description are exemplary and explanatory only and are not restrictive of the invention, as claimed.

### BRIEF DESCRIPTION OF THE DRAWINGS

FIG. 1 shows the correlation between the pixel position and the sensor cell of the liner sensor in one embodiment of the invention;

FIG. 2A schematically shows one embodiment of the invention;

FIG. 2B schematically shows another embodiment of the invention;

FIG. 3 is a flow chart of the embodiment as shown in FIG. 2A;

FIG. 4 is a flow chart of the embodiment as shown in FIG. 2B:

FIG. 5 is a flow chart for performing calculation according to the smooth image digital data; and

FIG. 6 shows schematically the method of enhancing modulation transfer function.

### DESCRIPTION OF THE PREFERRED EMBODIMENTS

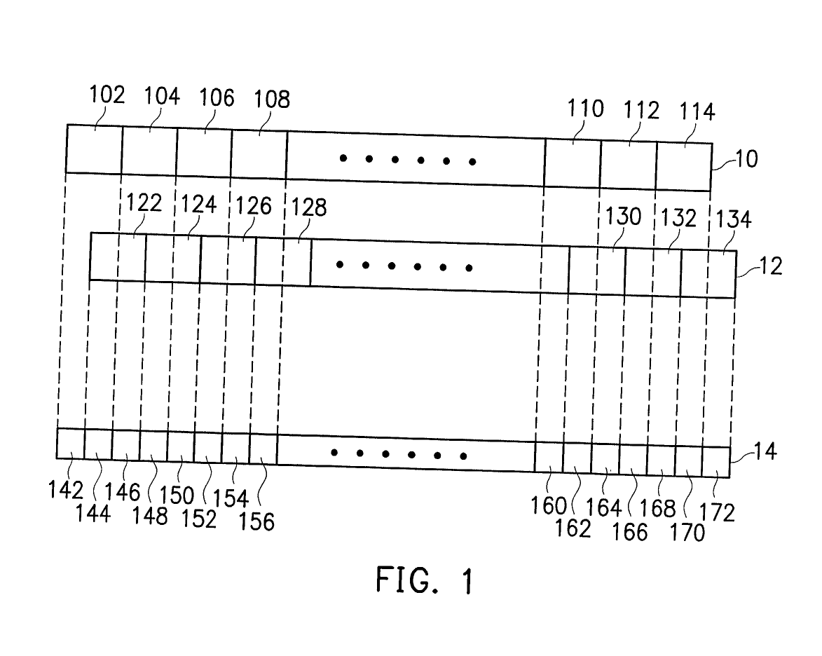

FIG. 1 shows one embodiment of the invention, in which the correlation between the pixel position and the sensor cells of the linear sensor is illustrated. The linear sensor includes the sensor set assembled by several sensor cells. For a color scanner, three sets of sensors are included in the linear sensor to process red, green and blue primary colors. In this embodiment, one set of sensors 10 is introduced and used as an example for explaining the invention, while other two sets of sensors have similar natures.

The above sensor set 10 includes sensor cells 102, 104, . . . , and 114. When the sensor set scans the object 14 between time t1 and t2, a fixed displacement results between scanning at t2 and scanning at t1. In this embodiment, the displacement between t1 and t2 is assumed to be ½ the width of one sensor cell. Superposition of a part of the sensor cells occurs to the object by the displacement of the sensor set 10 at two scanning times to divide into pixels 142, 144, . . . , to 172.

In the above embodiment, the example for using the linear sensor to scan along X-axis is described. The following further introduces the method of enhancing resolution.

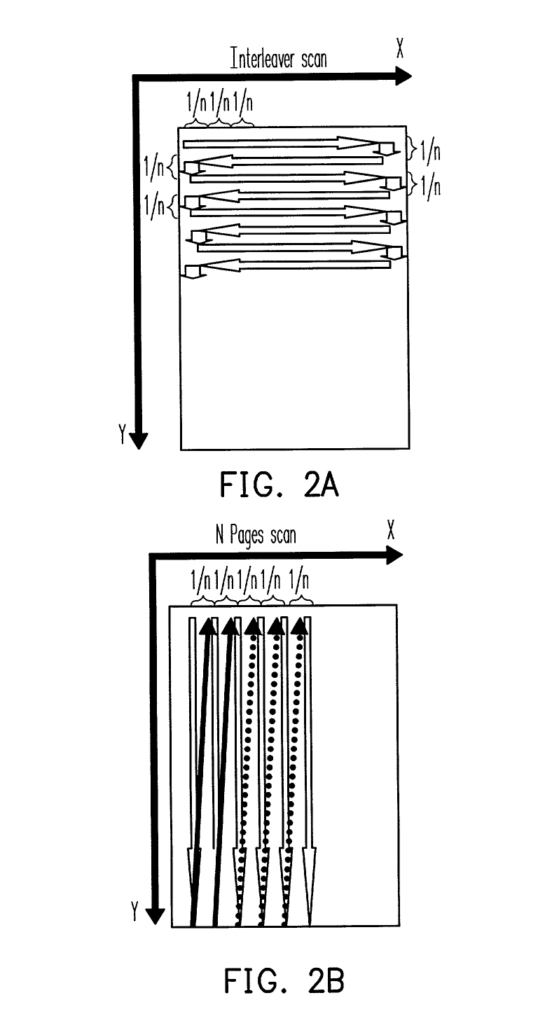

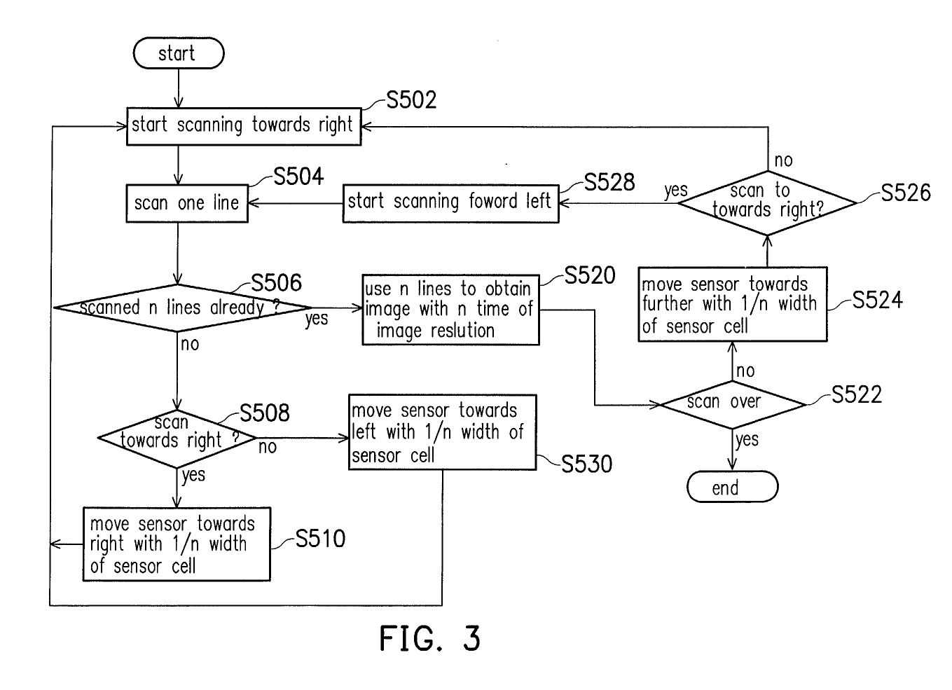

Referring to FIGS. 2A and 2B, two embodiments are illustrated. A typical linear sensor is used in the scanner in these two embodiments. Referring to both FIG. 2A and FIG. 3 illustrating the flow chart of the embodiment in FIG. 2A, in step S302, the scan is started, assuming towards the right. It is appreciated that people of ordinary skill in the art are able to start scanning in another direction, for example, towards the left. In step S304, digital data along a line is obtained. That is, digital data obtained by scanning one CCD set are obtained. In step S306, the subsequent process is determined according to the number of scanned lines obtained by scanning. Before the number of the scanned lines reaches a predetermined value n (that is, the width of one sensor cell), the next action is determined according to the current scan direction in step S308. When the sensor is scanning towards the right, the process goes to step S310, in which the sensor moves towards the right 1/n of the width of the sensor cell. Otherwise, the process goes to step S330 in which the sensor moves towards the left 1/n of the width of the sensor cell. After the sensor moves towards the right or left, the process goes back to step S302 for subsequent actions.

On the other hand, after confirming that the number of scanned lines reaches n, the process goes to step S320. The image resolution for a scanned line is multiplied by n via the n scanned lines. In step S322, whether the scan is finished is determined. If the scan is not finished, the process goes to step S324. In step S324, the sensor further moves 1/n of the width of the sensor cell to prepare for the next scan. In step S326, the scan direction for moving the sensor is determined according to the previous moving direction. If the scan direction is right before a further movement of the optical scanner, the process goes to step S328. If the scan direction is left before a further movement of the optical scanner, the process goes to step S302 and the optical sensor moves towards the right.

In the above X-Y directional scan, the X-directional scan is performed first until the number of scanned lines reaches the predetermined value n. The Y-directional scan is then performed.

In the following embodiment, the Y-directional scan is performed prior to the X-directional scan.

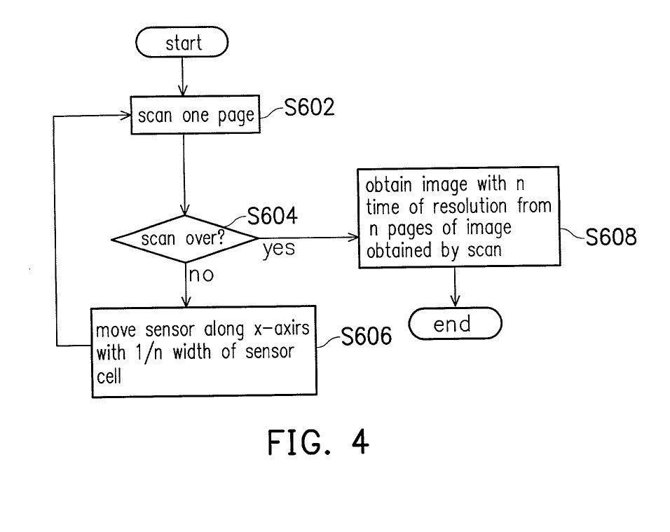

Referring to FIG. 4, a flow chart of the embodiment in FIG. 2B is shown. In this embodiment, the data of one page is scanned in step S402. In step S404, the subsequent process is determined according to whether the scan is finished or not. When the scan is not finished, the process goes to step S406. In step S406, the sensor moves along X-axis 1/n of the width of the sensor cell. The process goes back to step S402 with the position in the X-axis after the above movement as a reference. The image on the next page is then scanned. When the scan is finished in step S404 (the images on n pages are obtained in this embodiment), the images on the n pages are used to obtain n times of image resolution.

The above embodiment applies X-Y directional scans to enhance the resolution. To enhance the modulation transfer function after increasing the resolution, the digital data (that is, the brightness) of the pixel has to be obtained from a smooth image region with the same image brightness. Further, the digital data is used as a base for calculation to enhance the performance of modulation transfer function. The smooth image digital data is obtained prior to scanning the object. The smooth image digital data is obtained from a smooth image region with uniform scan brightness. The so-called smooth image region is similar to the optical black structure in the scanner. After scanning the optical black structure and data conversion, smooth image digital image is obtained.

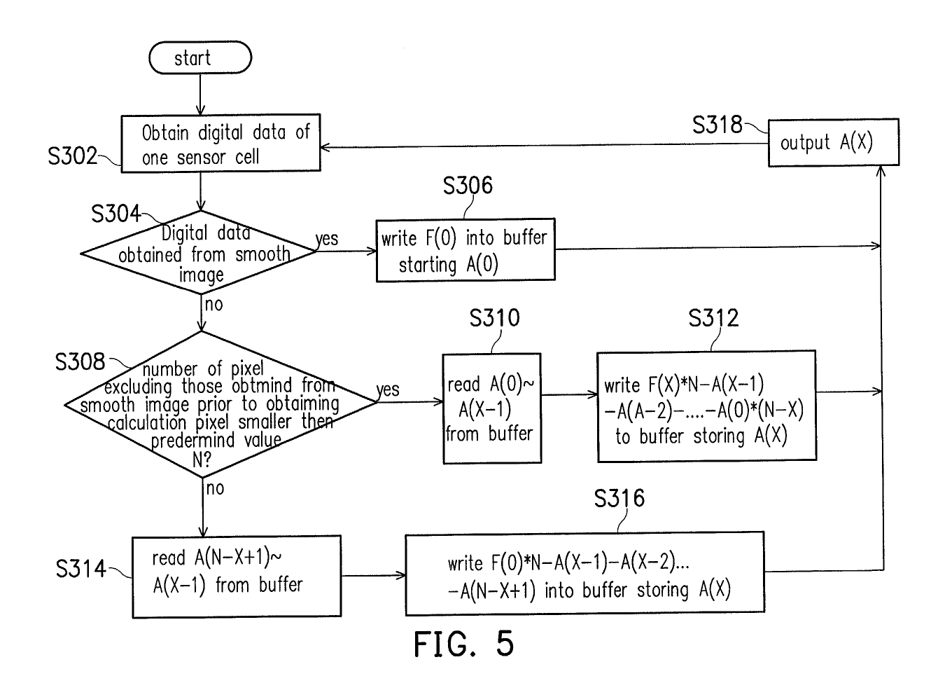

Therefore, no matter obtaining the image of a scanned line with n times of scan resolution, or obtaining n times of image resolution by scanning n pages of images, the process as shown in FIG. 5 is required to enhance the performance of modulation transfer function.

In FIG. 5, the flow chart for an embodiment of performing calculation according to the obtained smooth image region is shown. In step S502, a stored charge in a sensor cell is obtained. The charge is converted into digital data. That is, the sensed brightness of the sensor cell is obtained. The range detected by one sensor cell is called the number of calculation pixel. In step S504, whether the digital data obtained from the sensor cell belongs to a smooth image is determined. If the digital data belongs to a smooth image, step S506 is performed. Otherwise, the process goes to step S508. In step S506, as the digital data is the digital data of the smooth image, such digital data (F(0)) is written into the buffer storing the smooth region brightness (A(0)). The digital data is then output in step S518. The process then goes back to step S502 to obtain the next digital data.

When the process goes to step S508, the subsequent process is determined according to the digital data obtained from the smooth image and the pixel number of the obtained digital data. When the pixel number of the digital data is smaller than a predetermined value N, the process goes to step S510. Otherwise, the process goes to step S514. The predetermined value N is the required multiple for resolution increase. After entering step S510, the digital data obtained previously (assuming that the Xth calculation pixel is being scanned, so that there are X−1 digital data) is read from the buffer. That is, data for A(0), A(1), A(X−1) are read from the buffer. In step S512, the digital data F(X) obtained from the Xth calculation pixel is processed as follows:

A(X)=F(X)*N−A(X−1)−A(X−2)− . . . −A(0)*(N−X)

According to the digital data A(X) of the Xth pixel, the digital data A(X) is stored in the buffer. A(X) is then output step S502 to obtain the digital data of the next sensor cell.

When the pixel number of the obtained digital data is larger than the predetermined value N, the process goes from step S508 to step S514. In step S514, the digital data of the N pixels before the current calculation pixel, that is, the data A(X−1) to A(N−X+1) stored in the buffer, are read. According to the following equation:

A(X)=F(X)*N−A(X−1)−A(X−2)− . . . −A(X−N+1)

The digital data A(X) corresponding to the Xth pixel are obtained in step S516 and stored in the buffer. In step S518, A(X) is output. The digital data of the next calculation pixel are obtained in step S502.

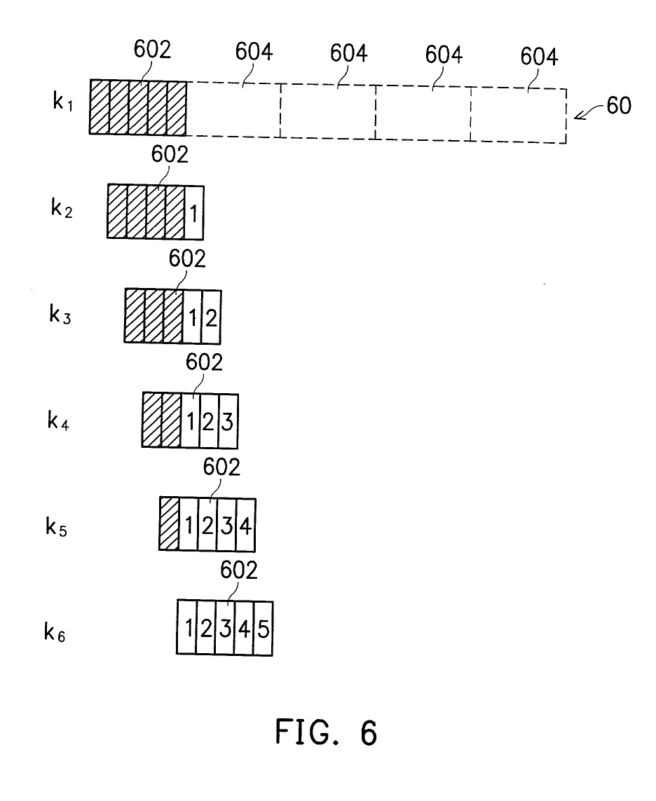

To further explain the embodiment in FIG. 5, the schematic drawing is shown in FIG. 6.

Referring to FIG. 5 and FIG. 6, the displacement of the sensor set 12 is ⅕ the width of the sensor cell, while the displacement of the sensor set 10 in FIG. 1 is ½ the width of the sensor cell. Therefore, the scanned ranged of the sensor cell is two pixels in FIG. 1, while the scanned range of the sensor cell is 5 pixels in FIG. 6. In this embodiment, the sensor 602 is used as an example for description.

In step S502, the charges stored in the sensor cell 602 are obtained and converted into digital data, that is, the brightness detected by the sensor cell 602. In step S504, whether the digital data obtained by the sensor cell 602 at time K1 belongs to a smooth image is determined. If the digital data belongs to the smooth image (that is, the hatched area), the digital data F(0) are written into the buffer to store the smooth brightness A(0). The digital data output at step S518. In the next step S502, the next digital data are obtained.

In the step S502, as not all of the digital data obtained by the sensor cell 602 at time K2, K3, K4 or K5 are of the smooth image, the process goes to step S508. In step S508, the subsequent process is determined according to the digital data obtained from the smooth image and the pixel number of the digital data. When the pixel number of the obtained digital data is smaller than the predetermined value N=5 (that is, the scanned range of 5 pixels for one sensor cell), the process goes to step S510. Otherwise, the process goes to step S514.

When entering step S510, the previously obtained digital data (assuming that the Xth calculation pixel is scanned, so that there are X−1 digital data) is read from the buffer. That is, the data A(0), A(1), . . . , A(X−1) are read from the buffer. Here, the sensor cell that has been scanned at time K5 is 602. Therefore, the data A(0), A(1) to A(3) are read from the buffer. The digital data A(4) of the fourth calculation pixel are processed as:

A(X)=F(X)*N−A(X−1)−A(X−2)− . . . −A(0)*(N−X)

That is, A(4)=F(4)*N−A(3)−A(2)−A(1)−A(0)*(5−4). Accordingly, the digital data A(4) of the fourth pixel are obtained. The digital data A(4) are stored in the buffer and output at step S518. The process then goes back to step S502 to obtain the digital data of the next sensor cell. F(4) is thus the digital data obtained by the scan of the sensor cell 602, including the calculation pixel A(4) to be obtained.

When the pixel number of the obtained digital data is larger than the predetermined value N−1=4, the process goes from step S508 to step S514. In step S514, the digital data of four pixels prior to the fifth calculation pixel, that is, the data A(1) to A(4) stored in the buffer are read. According to the following equation:

A(X)=F(X)*N−A(X−1)−A(X−2)− . . . −A(X−N+1)

A(5)=F(5)*5−A(4)−A(3)−A(2)−A(1) is obtained. In step S516, the digital data A(5) for the fifth pixel are obtained and stored in the buffer. In step S518, A(5) is output. The process goes back to step S502 to obtain the digital data for the next calculation pixel.

According to the above, the invention advantageously uses a sensor to scan both the image smooth region and the object, and obtains improved resolution in the X-axis and the Y-axis by moving the scanner in two perpendicular directions. To enhance the performance of modulation transfer function, the smooth image region is used to calculate the digital data (brightness) of each pixel. A better performance of modulation transfer function thus results.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

What is claimed is:

1. A method of enhancing modulation transfer function performance, applicable to a method of scanning an object using a scanner with a linear sensor, the method comprising:
obtaining smooth image digital data;
scanning the object in a forwarding direction and a direction perpendicular to the forwarding direction; and
processing digital data of a calculation pixel obtained by scanning the object according to the smooth image digital data.

2. The method according to claim 1, wherein the smooth image digital data is obtained prior to scanning the object.

3. The method according to claim 1, wherein the smooth image digital data is obtained from a smooth image region with a uniform scan brightness.

4. The method according to claim 1, wherein processing the digital data of the calculation pixel obtained by scanning the object further comprises:
when X>(N−1),
A(X)=F(X)*N−A(X−1)−A(X−2)− . . . −A(X−N+1); and
when X<N,
A(X)=F(X)*N−A(X−1)−A(X−2)− . . . −A(0)*(N−X);
wherein X−1 is a number of pixels of digital data obtained before obtaining the calculation pixel excluding the pixel contained in the smooth image digital data, N is a number of calculation pixel included in one sensor cell, A(X) is digital data of the Xth calculation pixel, A(0) is digital data of the smooth image pixel, and F(X) is digital data obtained by scanning of the sensor cell including the obtained calculation pixel.
